(19) United States
(12) Patent Application Publication
(10) Pub. No.: US 2006/0098160 A1
(43) Pub. Date: May 11, 2006

(54) Eyeglasses with temple arm supports

(76) Inventors: Shahrooz S. Jamie, Clay, WV (US); Sharon S. Jamie, Clay, WV (US)

Correspondence Address: BOWLES RICE MCDAVID GRAFF & LOVE LLP, POST OFFICE BOX 1386, CHARLESTON, WV, 25325-1386, US

(21) Appl. No.: 10/985,239

(22) Filed: Nov. 10, 2004

(51) Int. Cl. G02C 5/14

(52) U.S. Cl. 351/123

(57) ABSTRACT

Eyeglasses with additional temple arm supports for supporting the frame of a pair of eyeglasses off of and above the nose and nasal bone. The glasses are used by patients recovering from rhinoplasty surgery but who must still have use of eyeglasses which do not contact the nasal bone or nose. In one embodiment, the frame is suspended above the nose by an enhanced counterweighed ear loop. In another embodiment, a stanchion is provided supported by the zygomatic arch to elevate the temple arm. Several embodiments support the temple arm with additional mandibular and temple rests extending orthogonally from the temple. Several additional embodiments replace the conventional ear loop with a pair of support pads at the end of a shortened temple arm. The support pads press against the two bony protuberances on the side of the wearer's head. These protuberances include the zygomatic arch, the mandibular condyle, and the temple. Pressure by the support pads against two of these protuberances provides sufficient support for the entire weight of the eyeglasses. Another embodiment is comprised of a support hoop disposed on the temple arm. The upper arc of the hoop is supported by the temple while the lower arc is supported by the mandible.

### BACKGROUND OF THE INVENTION

1. Field of the Invention

The invention disclosed herein relates to eyeglasses and eyeglass frames with alternative means of support on the face.

2. Description of the Related Art

Eyeglasses are commonly used to correct vision impairments and as well as to protect the eyes in hazardous environments. Typical eyeglass frames are comprised of common structures for positioning the frame on the face of the wearer. These structures include temple arms, one end of which loops behind the ears, and a nose bridge or nose pads attached to the nose bridge, which rest upon the nose of a wearer. The two ear loops on the temple arms and the nose bridge or pads provide three points of contact with the face of the user, which provides sufficient support to maintain the frames in a desired position and alignment. The nose bridge or pads support a majority of the weight of the frames. The end loops of the temple arms engage with the cartilage of the ears and prevent the frame from sliding away from or down the nose.

Rhinoplasty, or cosmetic surgery to reshape the nose, is one of the more commonly administered forms of cosmetic surgery procedures. According to the American Society of Plastic Surgeons, in the year 2002 approximately 354,327 rhinoplasty procedures were performed. A substantial recovery period is involved after rhinoplasty, during which the nose is swollen, inflamed and painfully sensitive to touch or pressure. The inflammation and sensitivity usually preclude use of common types of eyeglass frames.

In other cases, the use of conventional eyeglass frames is undesirable because the nose pads cause indentation marks in the skin of the nose, or pull flaccid skin downward, causing cosmetically unappealing wrinkles in the skin around the nose.

The use of contact lenses may alleviate these undesirable consequences, but cannot be worn by or are uncomfortable to many people. Further, contact lenses do not provide any physical protection to the eye, and hard lenses disposed anterior of the eye are still necessary to provide this protection, as well as vision correction.

A number of examples of modified eyeglass frames are available in the prior art. For example, U.S. Pat. No. 182,013, issued to Andross on Sep. 12, 1876; U.S. Pat. No. 1,026,272, issued to Leveque on May 14, 1912 and U.S. Pat. No. 1,819,738, issued to Daniels on Feb. 23, 1928, each discloses a spectacles or eyeglasses wherein the lenses are supported by a frame that completely encircles the rear of the head. The spectacles are maintained on the head by pressing the frame around the lenses against the socket surrounding the eye using tension in the frame. This method can be uncomfortable and cause irritation to the skin around the eye socket.

U.S. Pat. No. 3,955,885, issued to Aronsohn on May 11, 1976, and U.S. Pat. No. 5,666,182, issued to Donner each disclose an eyeglass frame with a support member disposed, either permanently or removably, to the lower edge of the frame. These are capable of supporting the eyeglass frame off the bridge of the nose, but the positioning of the support member along the lower frame edge causes an obstruction to the downward field of vision, a disadvantage especially for those with bifocal lenses.

An eyeglass frame which supports the frame off the bridge of the nose without interfering with the normal field of vision is desirous.

### SUMMARY OF THE INVENTION

To alleviate or improve upon the disadvantages in the prior art, modifications to conventional eyeglass frames comprise a variety of elements to provide support for the frames on other portions of the wearer's face or head. These alternative support points position the eyeglass frames properly without the need for contact with the nasal bridge.

One objective of this invention is to provide an eyeglass frame with means for elevating the bridge on a typical frame off the nasal bridge.

Another objective is to support an eyeglass frame on the face by a part of the face or head other than the nasal bridge.

Another objective of this invention is to provide such means without impeding vision, especially in the downward direction.

These and other objectives and advantages of the invention will become apparent from the description which follows. In the description, reference is made to the accompanying drawings, which from a part hereof, and in which is shown by way of illustration specific embodiments in which the invention may be protected. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### DESCRIPTION OF THE DRAWINGS

FIG. 1 is a diagram displaying a conventional pair of eyeglasses in use.

FIG. 2 is a side elevation orthogonal view of a first embodiment of the invention.

FIG. 3 is a side elevation orthogonal view of a second embodiment of the invention.

FIG. 4 is a front elevation orthogonal view of a third embodiment of the invention.

FIG. 5 is a side elevation orthogonal view of a third embodiment of the invention.

FIG. 6 is a front elevation orthogonal view of a fourth embodiment of the invention.

FIG. 7 is a side elevation orthogonal view of a fourth embodiment of the invention.

FIG. 8 is a front elevation orthogonal view of a fifth embodiment of the invention.

FIG. 9 is a side elevation orthogonal view of a fifth embodiment of the invention.

FIG. 10 is a front elevation orthogonal view of a sixth embodiment of the invention.

FIG. 11 is a side elevation orthogonal view of a sixth embodiment of the invention.

FIG. 12 is a front elevation orthogonal view of a seventh embodiment of the invention.

FIG. 13 is a side elevation orthogonal view of a seventh embodiment of the invention.

FIG. 14 is a front elevation orthogonal view of an eighth embodiment of the invention.

FIG. 15 is a side elevation orthogonal view of an eighth embodiment of the invention.

FIG. 16 is a front elevation orthogonal view of a ninth embodiment of the invention.

FIG. 17 is a side elevation orthogonal view of a ninth embodiment of the invention.

FIG. 18 is a front elevation orthogonal view of a tenth embodiment of the invention.

FIG. 19 is a side elevation orthogonal view of a tenth embodiment of the invention.

### DETAILED DESCRIPTION OF THE INVENTION

The following discussion describes in detail one or more embodiments of the invention. The discussion should not be construed, however, as limiting the invention to those particular embodiments, and practitioners skilled in the art will recognize numerous other embodiments as well. The complete scope of the invention is defined in the claims appended hereto.

As used herein, the following words or terms have the indicated meaning:

“Inferior” or “inferiorly” means downward, towards the feet.

“Superior” or “superiorly” means upward, towards the top of the head.

“Lateral” or “laterally” means horizontally or in a horizontal direction away from the sagittal plane, either left, right, or both.

“Medial” or “medially” means horizontally or in a horizontal direction towards the sagittal plane of the body.

“Parasagittal” or “parasagitally” means in a plane parallel to the sagittal plane of the body.

“Sagittal” or “sagittally” means in a vertical plane passing through the vertical centerline of the body and dividing the body into right and left halves.

“Anterior” or “anteriorly” means towards the front of the body.

“Posterior” or “posteriorly” means towards the back of the body.

When the above anatomically related directions or orientations are used in reference to the disclosed invention, reference to the invention is based on the invention when worn in the customary manner or in the manner described for use on the face of a wearer.

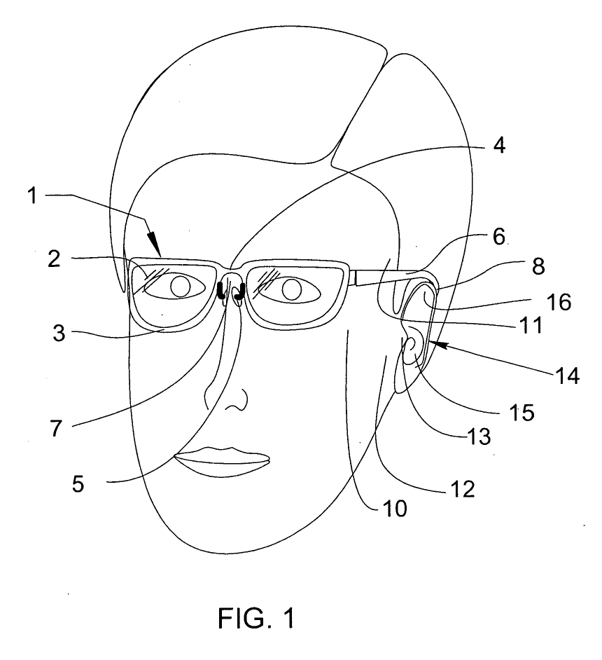

As shown in FIG. 1, a typical pair of conventional eyeglasses in the prior art is comprised of a pair of transparent lenses 2, each possibly enclosed within a circuitous frame 3, connected by a bridge 4, together forming an eyeglass frame 1. On the lateral edge of each frame 1 is disposed a temple arm 6, comprised of an elongated member articulated, usually pivotally, to the eyeglass frame 1 at one end and having an arcuate ear loop 8 at the other end. The bridge 4 is either shaped to conform with the shape of a typical nasal bridge, or has disposed on it a pair of nose pads 5, which are either adjustable or fixed, designed to rest upon the nasal bone 7.

The typical pair of eyeglasses is worn by resting the bridge 4, or the nose pads 5 if so equipped, on the nasal bone 7 and then engaging the ear loops 8 with the rear of the ear lobes. The friction of the nose pads 5 prevent the eyeglass frame from sliding down the nose, while the tension from the ear loops 8 maintain the eyeglass frame 1 in vertically in front of the eyes.

In some designs, the temple arms 6 are rigidly disposed at an angle generally perpendicular to the plane of the eyeglass frame 1. In other designs, the temple arms 6 pivotally engage with the eyeglass frame 1, permitting each temple arm to pivot and flex to a closed position behind and parallel to the plane of the eyeglass frame 1. When in use, the temple arms 6 are extended to the open position, perpendicular to the plane of the eyeglass frame 1. When the eyeglasses are donned by a wearer, the eyeglass frame 1 is substantially coplanar with the frontal plane of the wearer, and the temple arms 6 are coplanar with a parasagittal plane on either side of the head.

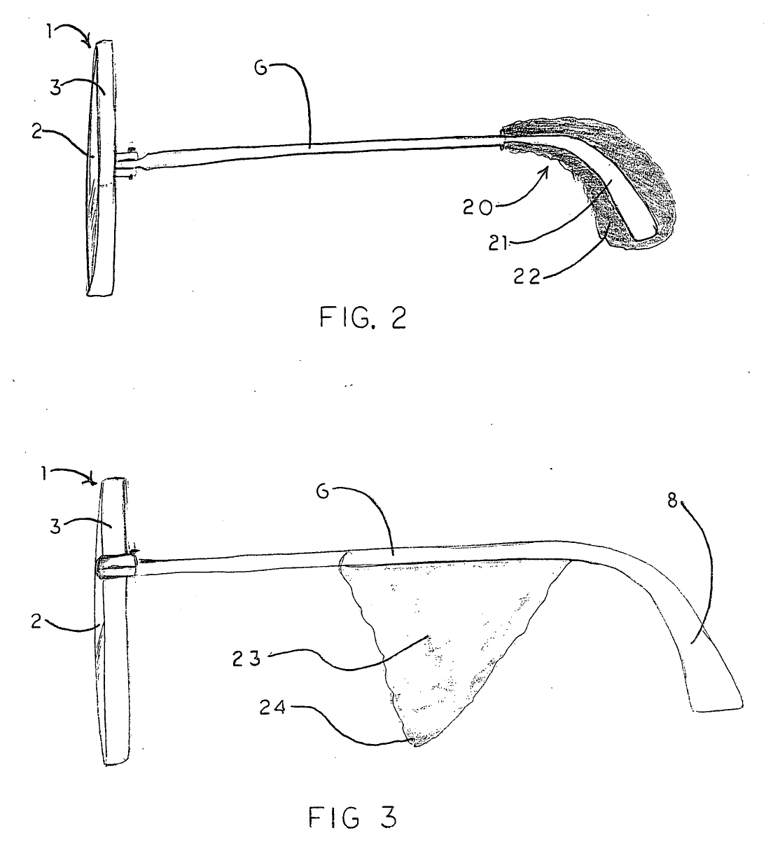

To achieve the objective of the present invention in providing a means for elevating the eyeglass frame 1 off the nasal bone 7 and supporting it by another part of the face or head, the invention disclosed herein, in one type of embodiment, utilizes an enhanced ear loop 20, shown in FIG. 2. The enhanced ear loop 20 is an apparatus that is weighed and molded to the general shape of the cavity behind the ear. The enhanced ear loop 20 is in the preferred embodiment comprised of a central core 21, which is surrounded by a pliable sheath 22.

The central core 21 provides structural rigidity and strength for the enhanced ear loop 20. The central core 21 is, in one embodiment, an extension of the material from which the temple arm 6 is fabricated, with an arcuate shape to conform with the cavity behind the ear. In another embodiment, the central core 21 is another material, including another metal more dense than the metal of the temple arm 6, bonded to the temple arm extension. Using another metal or material with a higher density, bonded to the core 21, provides additional weight in less space for achieving the objective of the invention. The weight of each enhanced ear loop 20 should be at least ⅜ of the total weight of the frame 1, including the lenses 2 and the bridge 4. The weight of the two enhanced ear loops 20 together will then equal at least 75% of the weight of the frame. Preferably, the weight of each enhanced ear loop 20 should be ½ the weight of the frame 1, thereby the combined weight of the two enhanced ear loops 13 would equal the weight of the frame 1. This weight is sufficient, when used with the additional grip provided behind the auricle of the ear by the malleable sheath, described below, to hold the frame 1 elevated above the nasal bone 7.

The radius of the ear loop central core 21 is selected to be only slightly greater than the perimeter of the conjunction of the auricle 7 with the side of the head, thereby providing a snug fit behind the ear. The arc of the ear loop 8 is preferably at least 90°, to extend the terminus of the ear loop 20 behind the lower part of the concha bowl 15.

Surrounding the central core 21 is a malleable sheath 22. The sheath is composed of an elastomer or polymer which is pliable and can deform plastically and may be manually shaped to a configuration matching the cavity behind the auricle. The sheath thickness increases towards the distal end of the ear loop 8, forming a flattened, curved teardrop shape.

In use, the eyeglasses are worn with the enhanced ear loops 20 snugly behind the auricular. The enhanced ear loops 20 are pivoted slightly posterior, thereby raising the frame 1 off the nasal bone 7. The sheath of the enhanced ear loop 20 is then manually molded with the thumb of each hand, forming the sheath into the cavity behind the concha bowl 26 of each ear. The grip of the enhanced ear loop 20 against the back external surface of the auricle 14, together with the counterbalancing weight of the enhanced ear loop 20, maintains the frame 1 in an elevated disposition above the nasal bone 7.

Another embodiment of the invention is shown in FIG. 3. As shown, the invention in this embodiment is comprised of a frame 1, comprised of a pair of laterally-aligned transparent lenses 2, a circuitous frame 3 circumscribing and enclosing each lens 2, if desired, and a bridge 4 disposed between the lenses 2, or their circuitous frames 3, if provided, engaging with the medial edges of each lens or circuitous frame 3. A pair of temple arms 6 is provided, each having a proximal and a distal end. The proximal end of each temple arm articulates with one of either the lateral edges of the frame 1, either rigidly or pivotally. An ear loop 8 is disposed at the distal end of each temple arm 6.

The improvement in this embodiment for achieving the objectives of the invention is provided in the form of a pliable stanchion 23 disposed on the temple arm 6. The stanchion 23 has a generally triangular or trapezoid shape, the base of which engages the temple arm 6 medial between the proximal and distal ends. The apex 24 of the stanchion 23 is orientated downward, and is generally shaped to effect engagement with the zygomatic arch 10, the bony protrusion located an inch to inch and a half anterior of the tragus 13 in FIG. 1 of the ear. The stanchion 23 may have a metallic core which is sufficiently rigid to support the stanchion 23 without yielding while sufficiently pliable to permit customized manual shaping of the stanchion 23.

To use this embodiment, the eyeglasses are worn and the frame 1 is gently lifted off the nasal bone 7. The stanchions 23 are pressed medially with the thumb of each hand, so that the downward-oriented apex 23 presses on the zygomatic arch 10 in FIG. 1, the bony protrusion located on the side of the head one to one and one-half inches anterior of the tragus 13 in FIG. 1 of the ear. The weight of the glasses is supported by the stanchion, maintaining the desired attitude of the frame 1 above and without contact to the nasal bone 7.

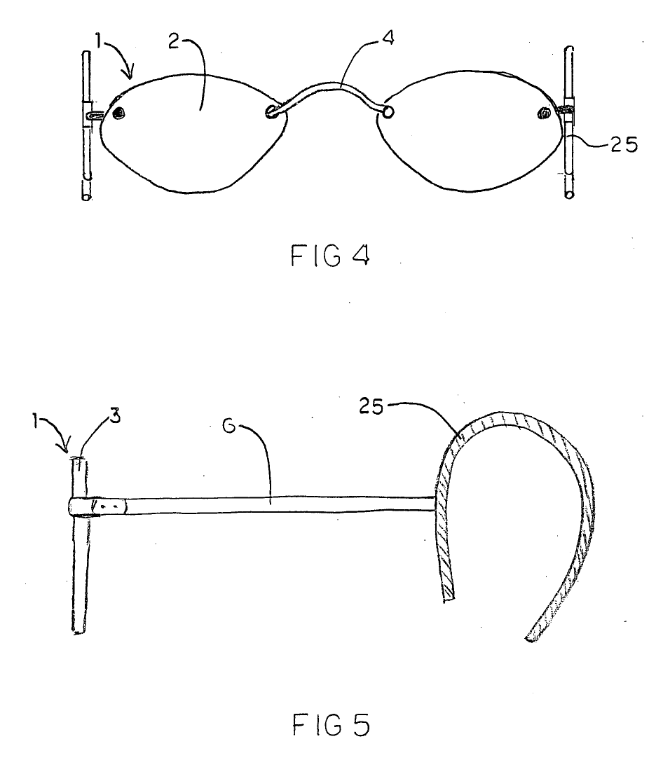

In another embodiment of this invention, alternative temple arm supports are provided by replacing the conventional ear loop 8 in FIG. 1 at the distal end of each temple arm 6 with an auricle saddle 25 as shown in FIGS. 4 and 5. This embodiment of the invention is comprised of a frame 1, comprised of a pair of lenses and, if desired, a circuitous frame 3 around each lens, and a bridge 4 disposed between the two lenses 2, engaging the medial edge of each lens or, if provided, the circuitous frames 3. A pair of temple arms 6 is provided, each having a proximal and distal end. The proximal end of each temple arm 6 articulates with one of either the lateral edges of the frame 1. Disposed on the distal end of each temple arm is an auricle saddle 25. The auricle saddle 25 is comprised of an elongated, curvilinear member having one section which circulates part of the posterior side of the auricle 14, and another section which circulates part of the anterior side. The distal end of the temple arm 6 articulates with the auricle saddle 25 between the anterior and posterior ends. The auricle saddle 25 is generally manufactured of the same material as the temple arm. Preferably, the material of the auricle saddle 25 should be slightly pliable, permitting manual reshaping of the auricle saddle 25 to conform snugly at the posterior end with the rear concha 15 surface and at the anterior end engaging snugly with the tragus 13 or anterior base of the helix 16, shown in FIG. 1. When correctly shaped, the auricle saddle 25 maintains the frame in an attitude above and without contact to the nasal bone 7, with the torque of the frame on the temple arm 6 counteracted by the support of the tragus 13 against the anterior end of the auricle saddle 25 and the friction against the posterior end of the auricle saddle 25 against the rear surface of the auricle 14 behind the concha 15.

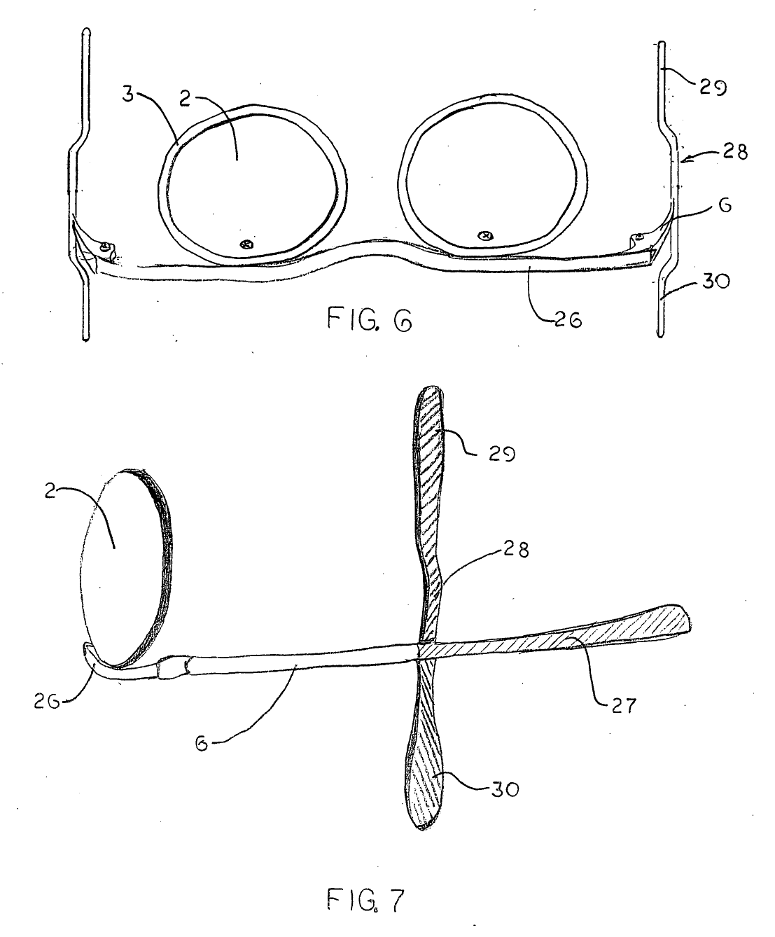

In another embodiment of the invention, alternative support members are provided which engage with the temple 11 and with the mandibular condyle 12, shown in FIG. 1. As shown in FIGS. 6 and 7, this embodiment is comprised of a frame 1, comprised of a pair of laterally-aligned transparent lenses 2 and, if desired, circuitous frames 3 around each lens 2, and further comprised of a support bar 26 disposed parallel to the lateral axis of and below the lenses 2 engaging the lenses 2, or the circuitous frames 3, if so provided, at their lower edges. The support bar 26 is generally a straight, linear element which may be bent, preferably with a slight upward arc in a section between the two lenses 2 to provided clearance over the nasal bone 7.

At either end of the support bar 26 are disposed a pair of temple arms 6. The proximal end of each of the temple arms 6 articulates with the end of the support bar 26. The articulation may be rigid or, preferably, pivotal using a hinge. An ear rest 27 is disposed at the distal end of the temple arm 6. The ear rest 27 is substantially straight and collinear with the temple arm 6.

A vertical support member 28 is disposed on each temple arm 6. The vertical support member 28 has a temple rest 29 at its upper end and a temporal mandibular joint (“TMJ”) joint rest 30 at its lower end. The ear rest 27, temple rest 29 and TMJ joint rest 30 all have expanded ends flattened on the medial side to increase the area of surface contact with the skin on the side of the head, thereby increasing both comfort and frictional hold.

The vertical support member 28 is constructed similar to the temple arm 6. Preferably, it has a metallic core which is surrounded by an elastomeric or polymeric sheath. The metallic core is slightly pliable, capable of being bent slightly to allow shaping the temple rest 29 and TMJ joint rest 30 firmly against the side of the head, regardless of the cranial shape of any particular user.

To use these glasses with the vertical support member 28, the arms of the temple rest 29 and TMJ joint rest 30 are bent slightly medial of the parasagittal plane of the temple arm 6. The eyeglasses are donned, with the ear rest 27 resting on top of the auricle of the ear, behind the helix 16, in FIG. 1. The temple rest 29 engages with the surface of the temple 11, and the TMJ rest 30 engages with the bony protrusion of the mandibular condyle 12. To best engage the temple and TMJ areas, the temple arm 6 preferably is orientated at a downward angle from horizontal anterior from the engagement with the ear. With the temple arms 6 in this attitude, horizontal alignment of the lenses 2 with the axis of the eyes is maintained by their disposition on top of the support bar 26, to which the temple arms 6 articulate.

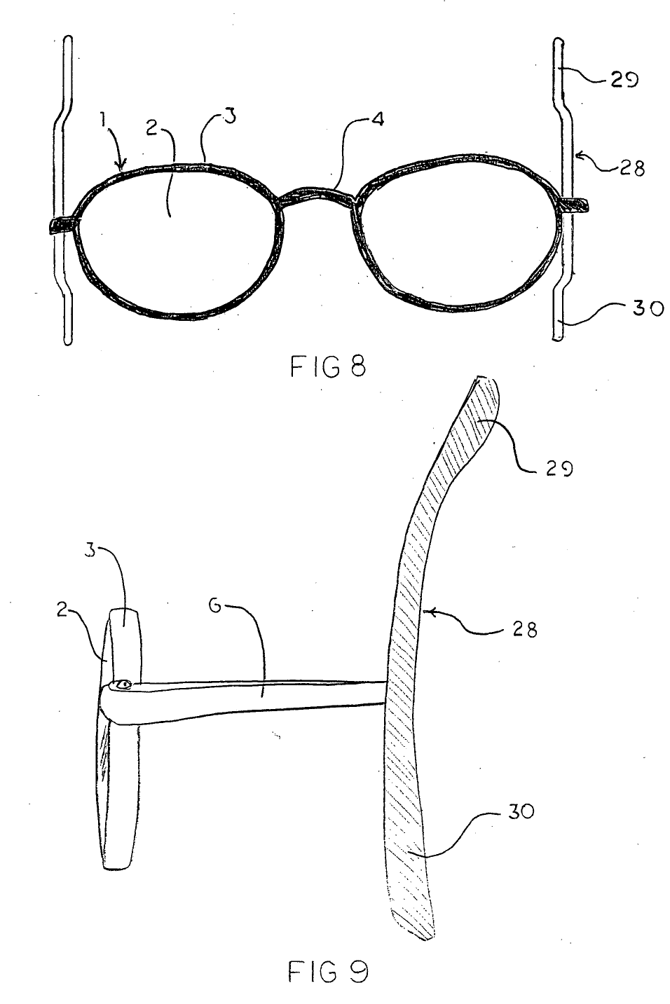

In another embodiment of the invention, as shown in FIGS. 8 and 9, elevation of the bridge 4 above the nasal bone 7 is achieved by providing a vertical support member 28, similar to the prior embodiment, which serves as the sole support for the frame 1 of the eyeglasses. In this embodiment, the invention is comprised of a frame 1 comprised of a pair of laterally-aligned transparent lenses 2, circumscribed by circuitous frames 3, if desired, and a bridge 4 disposed between the two lenses 2 or their circuitous frames 3, engaging either on their medial edges. On the lateral edge of each is disposed one of a pair of temple arms 6. The temple arms 6 in this embodiment are shorter than those of a conventional pair of eyeglasses, the length providing a distal end disposed at a point anterior of the ear. At the distal end of each temple arm 6 is disposed a vertical support member 28, having a temple rest at its upper end and a TMJ rest at its lower end. The vertical support member is longer than that of the prior embodiment, providing an extension at its upper end to the top of the temple bone on the typical skull, and at its lower end to the lower edge of the mandibular, or lower jaw. With the increased grip area provided by the longer vertical support member, an ear loop or ear rest may be entirely eliminated.

The temple arms 6 and vertical support members 26 are each constructed similarly to provide a small degree of pliability for shaping to conform with the side of the cranium. Preferably, the temple arms 6 and vertical support members 28 have a metallic wire core, enclosed by an elastomeric or polymeric sheath. When in use, the temple arms and the vertical support members are shaped to snugly engage the temple rest 29 and TMJ rest 30 with the corresponding points on the cranium and mandibular. With adequate pressure provided at these points by the temple rest 29 and TMJ rest 30, the glasses remain in position with the bridge 4 suspended above the nasal bone 7 without any additional support points.

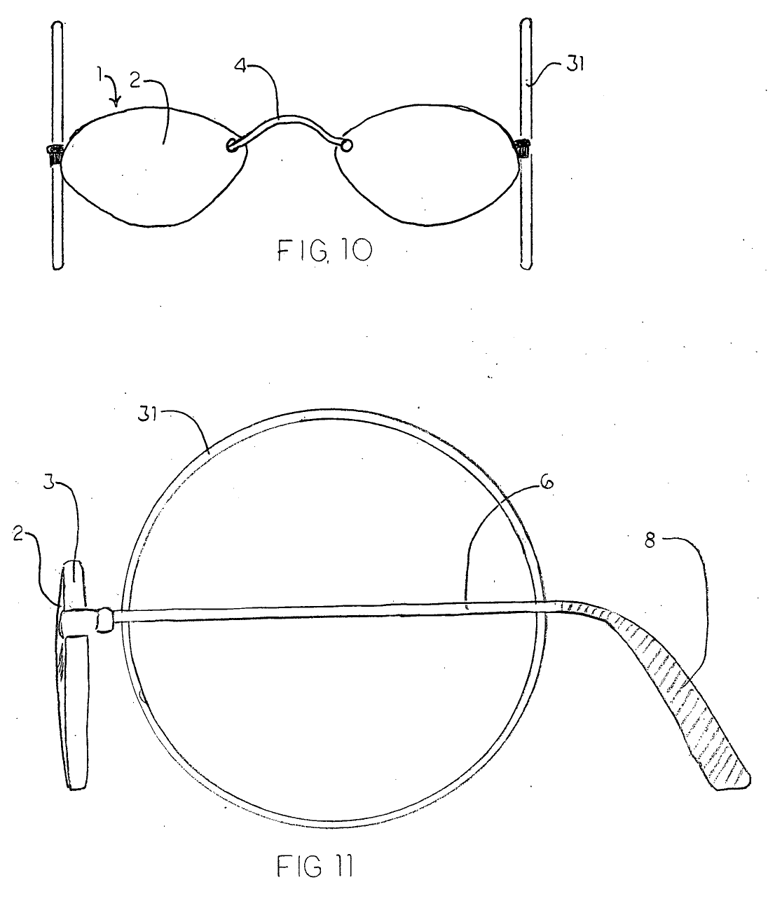

In another embodiment of the invention, additional support against the sides of the cranium is provided by a support hoop. As shown in FIGS. 10 and 11, the embodiment of the invention is comprised of a pair of laterally-aligned transparent lenses 2 and, if desired, a circuitous frame 3 circumscribing and enclosing each lens 2. A bridge 4 is disposed medially between the two lenses 2 and engages with the medial edge of each lens 2, or its circuitous frame 3, if provided. Further provided is a pair of temple arms 6, each having a proximal and a distal end. The proximal end of each temple arm 6 articulates with either lateral edge of the frame 1. This articulation may be fixed or, preferably, pivotal using a hinge. An ear loop 8 is disposed on the distal end of each temple arm 6. The improvement in this embodiment for achieving the objectives of the invention is comprised of a support hoop 31 disposed on each temple arm 6. The support hoop 31 is circular and fabricated preferably of corrosion-resistant wire or wire encased in an elastomeric or polymeric sheath. The diameter of the support hoop 31 is preferably 3 to 4 inches in diameter, but may be smaller or larger depending on the length of the temple arm utilized. The diameter of the support hoop 31 should be preferentially equal to the length from the proximal end of the temple arm 6 to the start of the ear loop 8 at the distal end, minus approximately ¾ of an inch. The support hoop 31 is disposed with its center on the temple arm 6, medially between the proximal and distal ends. The support hoop 31 is disposed in the parasagittal plane of the temple arm 6.

The eyeglasses are devised to effect a distance between the distal ends of the temple arms 6 in their extended configuration slightly less than the width of the head anterior of the ears. The temple arms 6 must, thus, be slightly flexed to place the temple arms 6 around the side of the head. Releasing the flexion causes the support hoop 31 to gently press medially against the sides of the head. The upper arc of the support hoop 31 rests against the temporal line of the frontal and parietal bones of the cranium, while the lower arc rests under the zygomatic arch 10. The pressure of the support hoop 31 against these points is sufficient to elevate and dispose the frame 1 above the nasal bone 7.

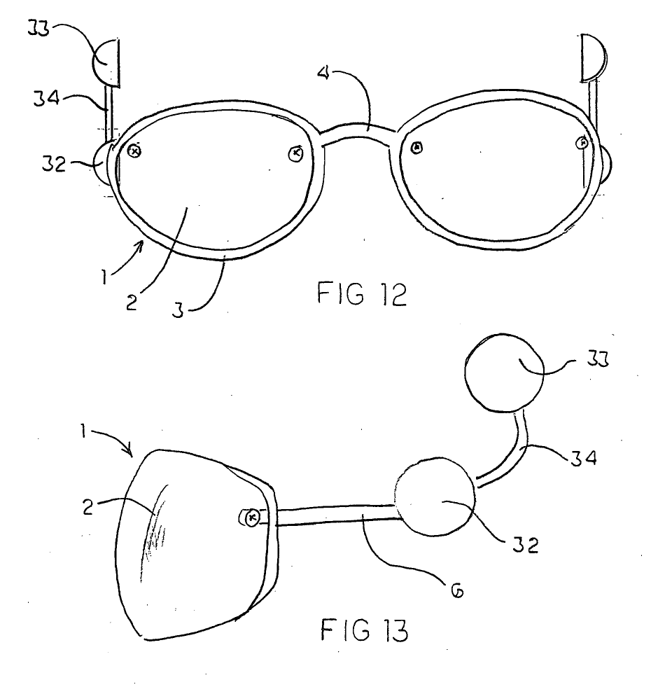

In another embodiment of the invention, the additional support is provided in the form of two support pads disposed on the temple arms 6 which engage the superior and inferior sides of the zygomatic arch 10 for support. As shown in FIGS. 12 and 13, this embodiment is comprised of a frame 1, comprised of pair of laterally-aligned transparent lenses 2, and, if desired, circuitous frames 3 circumscribing and enclosing each lens 2 and a bridge 4 disposed between the two lenses 2 and engaging the medial edges of the lens, or the circuitous frames 3, if provided; and further comprised of a pair of temple arms 6, each having a proximal end articulating with either of the lateral edges of the frame 1 and a distal end. The articulation with the frame 1 may be fixed, or, preferably, pivotal using a hinge. The improvement in this embodiment for achieving the objectives of the invention is comprised of a first and second support pads 32, 33 disposed on the distal end of each temple arm 6. The length of the temple arms 6 is shortened from those of conventional eyeglasses, to dispose the two support pads 32, 33 anterior of the auricle of the ear 14 in FIG. 1.

As shown in FIG. 13, a first support pad 32 is disposed collinear with the temple arm 6 longitudinal axis. The length of the temple arm 6 is specified to dispose the first support pad 32 for engagement with the lower part of the zygomatic arch 10 in FIG. 1, about one inch anterior of the tragus 13. At this position, the first support pad 32 will be located just inferior of the bony protuberance of the zygomatic arch 10. A second support pad 32 is disposed superior and posterior from the first support pad 32, and engages the first support pad by an arcuate connecting member 34. The first and second support pads 32, 33 are either a flat circular disk or a hemispheroid. In either design, a planar, preferably circular surface is presented by each support pad for engagement with the side of the head of the wearer. The diameter of each support pad 32, 33 is preferably ¾ to 1 inch in diameter. Each support pad 32, 33 is preferably fabricated of a non-corrosive metal, such as stainless steel or gold or nickel plated metal. The support pads 32, 33 may also be fabricated of tough polymer resins, such as high density polyethylene, acetal, or nylon.

The construction of the eyeglasses is configured such that the distance between the distal ends of the temple arms 6 in their extended configuration is slightly less than the width of the head interior of anterior of the ears. With this configuration the temple arms 6 must be slightly flexed to place the temple arms around the side of the head. Releasing the flexion causes the support pads 32, 33 to gently press medially against the sides of the head. The pressing engagement of the support pads 32, 33 on the side of the zygomatic arch 10 is sufficient to hold the temple arms 6 in a fixed attitude, with the frame 1 either including the bridge 4 disposed above and free from the nasal bone 7.

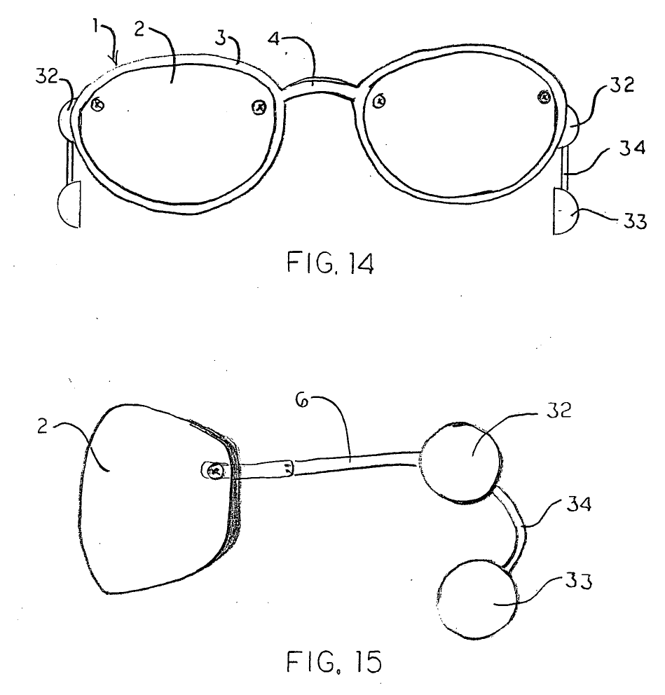

In another embodiment similar to the prior one, additional supports for the temple arms are provided by a pair of support pads. As shown in FIGS. 14 and 15, this embodiment is comprised of a pair of transparent lenses 2 laterally aligned and, if desired, a circuitous frame 3 circumscribing and enclosing each lens 2. A bridge 4 is disposed medially between the two lenses 2 and engages with the medially edge of each lens 2 or its circuitous frame 3, if provided. Further provided is a pair of temple arms 6, each having a proximal and a distal end. The distal end of each temple arm 6 articulates with either lateral edge of the frame 1. This articulation may be fixed or preferably pivotal using a hinge. The improvement in this embodiment for achieving the objective of the invention again is comprised of a pair of support pads 32, 33 disposed on the distal end of each temple arm 6. The length of the temple arms 6 is shortened from those of conventional eyeglasses, to dispose the two support pads 32, 33 anterior of the auricle 14 of the ear.

As shown in FIGS. 14 and 15, a first support pad 32 is disposed collinear with the longitudinal axis of the temple arm 6. The length of the temple arm 6 is devised to effect engagement of the first support pad 32 with the lower part of the zygomatic arch 10, in FIG. 1, about 1 inch anterior of the tragus 13. At this position, the first support pad 32 will be disposed just superior of the bony protuberance of the zygomatic arch 10. A second support pad 33 is disposed inferior and aligned substantially vertical to the first support pad 32. An arcuate connecting member 34 articulates with the first support pad 32 at one end and the second support pad 33 at the other. The connecting member 34 is devised to dispose the second support pad 33 at the desired aspect with the first support pad 32. The second support pad 33 is disposed to engage with the mandibular or jaw bone.

As before, each support pad 32, 33 may be constructed of a non-corrosive metal, such as stainless steel or gold or nickel plated metal, or tough polymeric resins, such as high density polyethylene, acetal or nylon. Each support pad 32, 33 is preferably ¾ to 1 inch in diameter. Each support pad 32, 33 may be constructed in shape of either a flat circular disk or a hemispheroid. In either design, a planar, preferably circular surface is presented by each support pad 32, 33 for engagement with the side of the head of the wearer. Each support pad 32, 33 is preferably fabricated of a non-corrosive metal, such as stainless steel or gold or nickel plated metal. The support pads may also be fabricated of tough polymer resins, such as high density polyethylene, acetal, or nylon.

The eyeglasses are devised to effect a distance between the distal ends of the temple arms 6 in their extended configuration slightly less than the width of the head interior of anterior of the ears. The temple arms 6 must, thus, be slightly flexed to place the temple arms 6 around the side of the head. Releasing the flexion causes the support pads to gently press medially against the sides of the head. The pressing engagement of the support pads 32, 33 is sufficient to hold the temple arms 6 in a fixed attitude, with the frame 1 and bridge 4 disposed above and free from the nasal bone 7.

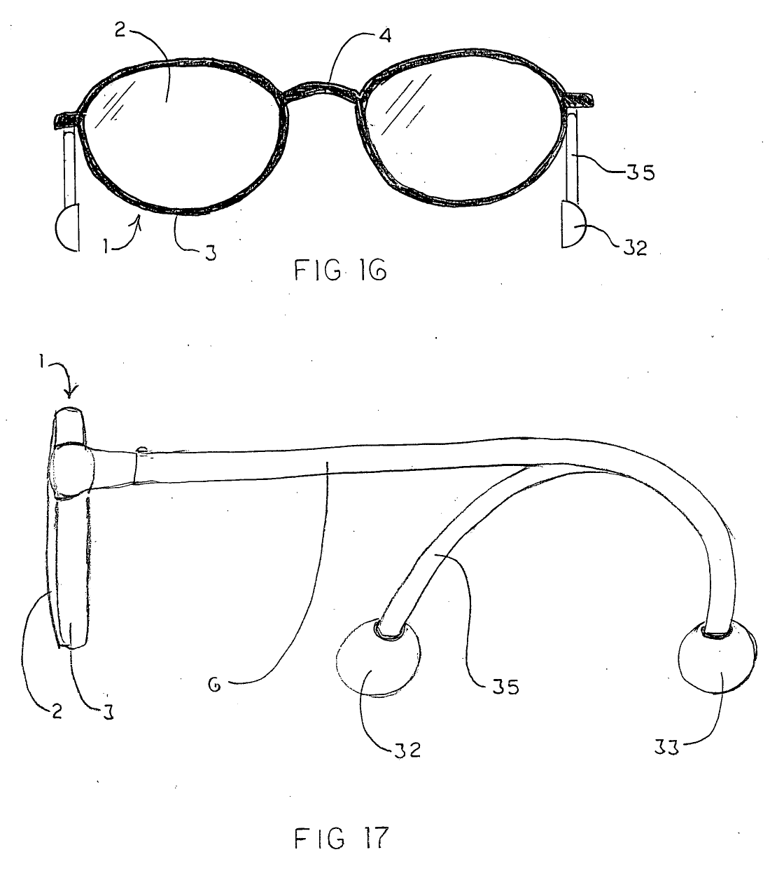

In another embodiment of this invention, alternative temple arm supports are provided by a pair of support pads aligned horizontally on opposite ends of an arcuate connecting member. As shown in FIGS. 16 and 17, this embodiment of the invention is comprised of a frame 1, the frame having a pair of transparent lenses 2 laterally aligned, and, if desired, a circuitous frame 3 circumscribing and enclosing each lens. A bridge 4 is disposed between the two lenses 2, or the circuitous frames 3, if provided, engaging with their medial edges. A pair of temple arms 6 is provided, each temple arm 6 having a proximal end which articulates with either of the lateral edges of the frame 1. The improvement for this embodiment to achieve the objectives of the invention includes a second connecting member 35 disposed on the end of each temple arm 6. The second connecting member 35 is constructed similarly to the temple arm 6 and in a preferred embodiment is comprise of a wire core with a polymeric sheath. The second connecting member 35 is preferably semicircular in shape or semielliptical, orientated concave downward. The distal end of the temple arm 6 articulates near the center of the second connecting member 35.

The length of the temple arms 6 and the diameter of the arc of the second connecting members 35 are configured to disposed the first support pad 32, the posterior pad slightly anterior of the tragus 13 of the ear, and engaging with the mandibular condyle 12, the bony protuberance at the temporal mandibular joint, and to dispose the second support pad 33, the anterior pad, to engage with the zygomatic arch 10.

As before, each support pad 32, 33 is preferably constructed of a non-corrosive metal, such as stainless steel or gold or nickel plated metal, or tough polymeric resins, such as high density polyethylene, acetal or nylon. Each support pad 32, 33 is preferably ¾ to 1 inch in diameter. Each support pad 32, 33 may be constructed in shape of either a flat circular disk or a hemispheroid. In either design, a planar, preferably circular surface is presented by each support pad for engagement with the side of the head of the wearer.

The eyeglasses are devised to effect a distance between the distal ends of the temple arms 6 in their extended configuration slightly less than the width of the head anterior of the ears. With this configuration the temple arms 6 must be slightly flexed to place the temple arms 6 around the side of the head. Releasing the flexion causes the support pads 32, 33 to gently press medially against the sides of the head. The pressing engagement of the support pads 32, 33 is sufficient to hold the temple arms 6 in a fixed attitude, with the frame 1 and bridge 4 disposed above and free from the nasal bone 7.

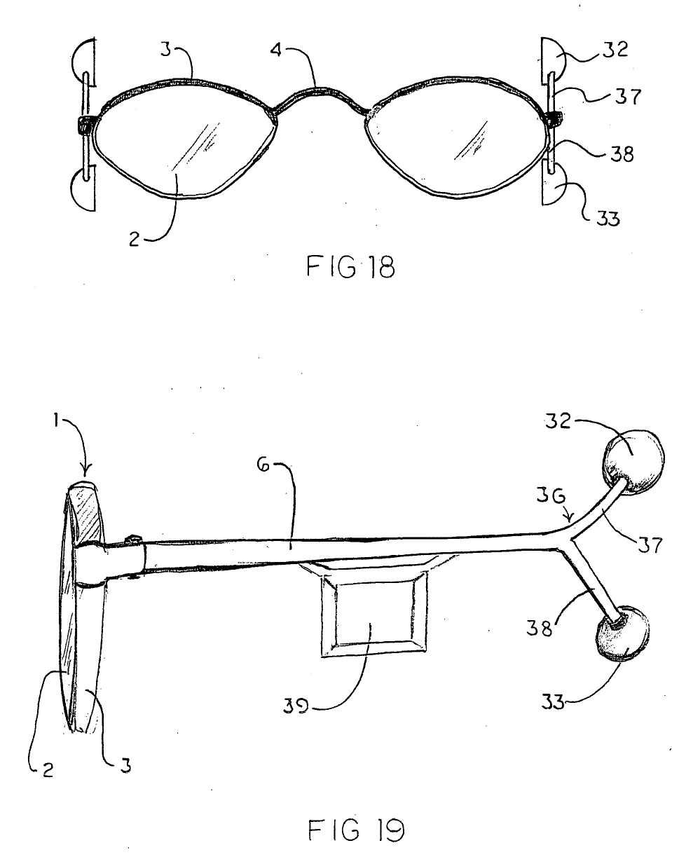

In a final embodiment of the invention, alternative temple arm supports are provided by a pair of support pads on either end of a forked connecting member. This embodiment of the invention, shown in FIGS. 18 and 19, is comprised of a frame 1, having a pair of transparent lenses 2 laterally aligned, and, if desired, a circuitous frame 3 circumscribing and enclosing each lens 2. A bridge 4 is disposed between the two lenses 2, or the circuitous frames 3, if provided, engaging with their medial edges. A pair of temple arms 6 is provided, each temple arm 6 having a proximal end which articulates with either of the lateral edges of the frame 1. The improvement for this embodiment to achieve the objectives of the invention includes a branched connecting member 36 disposed on the end of each temple arm 6. The branched connecting member 36 has an anterior end which conjoins coaxially with the distal end of the temple arm 6. The branched connecting member 36 extends posteriorly from the conjoination with the distal end of the temple arm 6, and then splits into superior 37 and inferior 38 branches. Each branch 37, 38 extends arcuately above and below, respectively, from the longitudinal axis of the temple arm 6. At the end of each branch 37, 38 is disposed a support pad 32, 33. The length of the temple arm 6 and the two branches 37, 38 are so devised to effect engagement the first, upper support pad 32 with the temple of the side of the head, just anterior of the auricle of the ear, and the second, lower support pad 33 with the mandibular condyle 12, vertically below the first support pad 32.

As before, each support pad 32, 33 is preferably constructed of a non-corrosive metal, such as stainless steel or gold or nickel plated metal, or tough polymeric resins, such as high density polyethylene, acetal or nylon. Each support pad 32, 33 is preferably ¾ to 1 inch in diameter. Each support pad 32, 33 may be constructed in shape of either a flat circular disk or a hemispheroid. In either design, a planar, preferably circular surface is presented by each support pad 32, 33 for engagement with the side of the head of the wearer.

The eyeglasses are devised to effect a distance between the distal ends of the temple arms 6 in their extended configuration slightly less than the width of the head anterior of the ears. The temple arms 6 must, thus, be slightly flexed to place the temple arms 6 around the side of the head. Releasing the flexion causes the support pads 32, 33 to gently press medially against the sides of the head. The pressing engagement of the support pads 32, 33 is sufficient to hold the temple arms 6 in a fixed attitude, with the frame 1 and bridge 4 disposed above and free from the nasal bone 7.

In a variation of this embodiment, a small mounting plate 39 is provided on each temple arm 6. An ornamental design or photograph may be affixed on the mounting plate 39 to provide additional decorative value to the glasses. A mounting plate 39 is disposed on the lateral side of each temple arm 6 in the parasagittal plane. In this orientation, an ornamentation disposed on the mounting plate 39 is readily visible by others adjacent to the person wearing the glasses.

While various embodiments of the invention have been described above, it should be understood that they have been presented by way of example, and not limitation. It will be apparent to person skilled in the relevant art that various changes in form and detail may be made therein without departing from the spirit, and scope and application of the invention. This is especially true in light of technology and terms within the relevant art that may be later developed. Thus, the present invention should not be limited by any of the above-described exemplary embodiments, but should only be defined in accordance with the appended claims and their equivalents.

We claim:

1) Eyeglasses with temple arm supports, comprised of:
a) a frame, comprised of a pair of lenses disposed laterally adjacent to one another and a bridge disposed between the two lenses and engaging the medial edge of either lens;
b) a pair of temple arms, each having a proximal end articulating with one lateral edge of the frame, and a distal end; and,
c) a pair of enhanced ear loops, one each disposed at the distal end of each temple arm, each enhanced ear loop comprised of an arcuate rigid core and a malleable sheath.

2) The eyeglasses of claim 1, wherein the weight of each enhanced ear loop is at least one half the weight of the frame.

3) The eyeglasses of claim 1, wherein the weight of each enhanced ear loop is at least three-eighths the weight of the frame.

4) The eyeglasses of claim 1, wherein the articulation of the temple arms with the frame is rigid.

5) The eyeglasses of claim 1, wherein the articulation of the temple arms with the frame is pivotal.

6) Eyeglasses with temple arm supports, comprised of:
a) a frame, comprised of a pair of transparent lenses disposed laterally adjacent and a bridge disposed medially between the two lenses engaging the medial edges of each lens, said frame having opposite lateral edges;
b) a pair of temple arms, each of said temple arms having a proximal end articulating with either of the lateral edges of the frame, and each having a distal end;
c) an ear loop disposed on the distal end of each temple arm; and,
d) a stanchion disposed on each temple arm.

7) The eyeglasses of claim 6, wherein the stanchion is disposed on the inferior side of the temple arm.

8) The eyeglasses of claim 6, wherein the stanchion is comprised of a pliable metallic core and a sheath.

9) The eyeglasses of claim 8, wherein the sheath is comprised of an elastomeric or polymeric resin.

10) The eyeglasses of claim 6, wherein the stanchion is substantially triangular in shape.

11) The eyeglasses of claim 6, wherein the frame is further comprised of a circuitous frame circumscribing and enclosing each lens, and the bridge engages the medial edge of each circuitous frame.

12) Eyeglasses with temple arm support, comprised of:
a) a frame, comprised of a pair of laterally adjacent transparent lenses and a bridge disposed between the two lenses engaging the medial edges of each lens, said frame having opposite lateral edges;
b) a pair of temple arms, each of which having a proximal end articulating with either lateral edge of the frame, and each having a distal end; and,
c) an auricle-saddle disposed on the distal end of each temple arm, said auricle-saddle comprised of a first arcuate member extending posteriorly and inferiorly from the distal end of the temple arm, and a second arcuate member extending anteriorly and inferiorly from the distal end.

13) The eyeglasses of claim 12, wherein the auricle-saddle is comprised of a metallic wire core surrounded by a polymeric or elastomeric sheath.

14) Eyeglasses with temple arms supports, comprised of:
a) a frame, comprised of a pair of laterally adjacent transparent lenses and a bridge disposed between the two lenses engaging the medial edges of each lens, said frame having opposite lateral edges;
b) a pair of temple arms, each having a proximal end articulating with one end of the support bar and a distal end; and,
c) a vertical support member disposed on the distal end of each temple arm, said vertical support member having a temple rest disposed on the superior end and a temporal mandibular joint rest on the inferior end.

15) The eyeglasses of claim 14, wherein the vertical support bar articulates with the distal end of the temple arm at a substantially orthogonal angle.

16) The eyeglasses of claim 14, wherein the articulation of the proximal end of the temple arm with the end of the support bar is rigid.

17) The eyeglasses of claim 14, wherein the articulation of the proximal end of the temple arm with the end of the support bar is pivotal.

18) The eyeglasses of claim 14, wherein the temple rest and the temporal mandibular joint rest are comprised of an expansion in the width of the vertical support member and a planar surface of the medial side for engagement with the surface of the face of a wearer.

19) The eyeglasses of claim 14, 15, 16, 17 and 18, further comprised of an ear rest, said ear rest comprised of an elongated member disposed at a first end with the articulation of distal end of the temple arm and the vertical support member, extending posteriorly along an extension of the longitudinal axis of the temple arm to a second end.

20) The eyeglasses of claim 19, where the ear rest is comprised of an expansion of the lateral width of the elongated member at its second end.

21) Eyeglasses with temple arm supports, comprised of:
a) a frame, comprised of a pair of laterally adjacent transparent lenses and a bridge disposed between the two lenses engaging the medial edges of each lens, said frame having opposite lateral edges;
b) a pair of temple arms, each having a proximal end articulating with one end of the support bar and a distal end;
c) an ear loop disposed on the distal end of each temple arm; and,
d) a support hoop; said support hoop comprised of an elongated, circular member, the diameter of which is less that the length of the temple arm and which is disposed on the temple arm, the center of the support hoop aligned with the longitudinal axis of the temple arm.

22) The eyeglasses of claim 21, wherein the articulation of the proximal end of the temple arm with the frames is rigid

23) The eyeglasses of claim 21, wherein the articulation of the proximal end of the temple arm with the frame is pivotal.

24) The eyeglasses of claim 21, wherein the diameter of the support hoop is substantially ¾ inch less than the length of the temple arm.

25) The eyeglasses of claim 21, wherein the frame is further comprised of a circuitous frame circumscribing and enclosing each lens, and the bridge articulates with the medial edge of each circuitous frame.

26) The eyeglasses of claim 21, wherein the center of the support hoop is aligned with the center of the temple arm.

27) Eyeglasses with temple arm supports, comprised of:
a) a frame, comprised of a pair of laterally adjacent transparent lenses and a bridge disposed between the two lenses engaging the medial edges of each lens, said frame having opposite lateral edges;
b) a pair of temple arms, each of which having a proximal end articulating with either lateral edge of the frame, and each having a distal end;
c) a first support pad disposed on the distal end of each temple arm, wherein the center of said first support pad is aligned with the longitudinal axis of each temple arm; and,
d) a second support pad, said second support pad is disposed superior and posterior to the first support pad and articulated with the first support pad by an elongated connecting member.

28) The eyeglasses of claim 27, wherein the connecting member is curved.

29) The eyeglasses of claim 28, wherein the curvature of the connecting member is concaved upward.

30) The eyeglasses of claim 27, wherein the first and second support pads are circular disks.

31) The eyeglasses of claim 27, wherein the first and second support pads are hemispheroids with a planar surface disposed medially.

32) The eyeglasses of claim 27, wherein the articulation of the proximal end of each temple arm with the frame is rigid.

33) The eyeglasses of claim 27, wherein the articulation of the proximal end of each temple arm with the frame is pivotal.

34) The eyeglasses of claim 27, wherein the frame is further comprised of circuitous frame circumscribing and enclosing each lens, and the bridge articulates with the medial edge of each circuitous frame.

35) Eyeglasses with temple arm supports, comprised of:
a) a frame, comprised of a pair of laterally adjacent transparent lenses and a bridge disposed between the two lenses engaging the medial edges of each lens, said frame having opposite lateral edges;
b) a pair of temple arms, each of which having a proximal end articulating with either lateral edge of the frame, and each having a distal end;
c) a first support pad disposed on the distal end of each temple arm, wherein the center of said support pad is aligned with the longitudinal axis of the temple arm; and,
d) a second support pad is disposed vertically inferior of the first support pad and articulated with the first support pad by an elongated connecting member.

36) The eyeglasses of claim 35, wherein the connecting member is curved.

37) The eyeglasses of claim 36, wherein the arc of the connecting member is concave anteriorly.

38) The eyeglasses of claim 35, wherein the first and second support pads are circular disks.

39) The eyeglasses of claim 35, wherein the first and second support pads are hemispheroids with a medially disposed planar surface.

40) The eyeglasses of claim 35, wherein the articulation of the proximal end of each temple arm with the frame is rigid.

41) The eyeglasses of claim 35, wherein the articulation of the proximal end of each temple arm with the frame is pivotal.

42) The eyeglasses of claim 35, wherein the frame is further comprised of a circuitous frame circumscribing and enclosing each lens and the bridge articulates with the medial edge of each circuitous frame.

43) Eyeglasses with temple arm supports, comprised of:
a) a frame, comprised of a pair of laterally adjacent transparent lenses and a bridge disposed between the two lenses engaging the medial edges of each lens, said frame having opposite lateral edges;
b) a pair of temple arms, each of which having a proximal end articulating with either lateral edge of the frame, and each having a distal end;
c) a connecting member disposed at the distal end of each temple arm, said connecting member having an arcuate shape with an anterior end and a posterior end aligned on a long substantially parallel and inferior to the longitudinal axis of the temple arm; and,

44) The eyeglasses of claim 43, wherein the distal end of the temple arm articulates with the center of the connecting member.

45) The eyeglasses of claim 43, wherein the first and second support pads are circular disks.

46) The eyeglasses of claim 43, wherein the first and second support pads are hemispheroids with a medially disposed planar surface.

47) The eyeglasses of claim 43, wherein the articulation of the proximal end of each temple arm with the frame is rigid.

48) The eyeglasses of claim 43, wherein the articulation of the proximal end of each temple arm with the frame is pivotal.

49) The eyeglasses of claim 43, wherein the frame is further comprised of a circuitous frame circumscribing and enclosing each lens and the bridge articulates with the medial edge of each circuitous frame.

50) The eyeglasses of claim 43, wherein the connecting member is semicircular in shape.

51) The eyeglasses of claim 43, wherein the connecting member is semi-elliptical in shape.

52) Eyeglasses with temple arm supports, comprised of:
a) a frame, comprised of a pair of laterally adjacent transparent lenses and a bridge disposed between the two lenses engaging the medial edges of each lens, said frame having opposite lateral edges;
b) a pair of temple arms, each of which having a proximal end articulating with either lateral edge of the frame, and each having a distal end;
c) a branched connecting member, said branched connecting member comprised of an elongated stem with an anterior end articulating with the distal end of the temple arm, said stem disposed collinearly with the temple arm, a superior and an inferior branch each articulating with a posterior end of the stem and each having a terminal end; and
d) a support pad disposed on the terminal end of the superior branch and inferior branch of each branched connecting member.

53) The eyeglasses of claim 52, wherein the lengths of the superior and inferior branches of the branched connecting member are equal.

54) The eyeglasses of claim 52, wherein the bisection of the angle between the superior and inferior branches of each branched connecting member is collinear with the longitudinal axis of the temple arm.

55) The eyeglasses of claim 52, wherein the two support pads on each branched connecting member are circular disks.

56) The eyeglasses of claim 52, wherein the two support pads one each branched connecting member are hemispheroid with a medially disposed planar surface.

57) The eyeglasses of claim 52, wherein the articulation of the proximal end of each temple arm with the frame is rigid.

58) The eyeglasses of claim 52, wherein the articulation of the proximal end of each temple arm with the frame is pivotal.

59) The eyeglasses of claim 52, wherein the frame is further comprised of a circuitous frame circumscribing and enclosing each lens and the bridge articulates with the medial edge of each circuitous frame.
